(19) United States
(12) Patent Application Publication
(10) Pub. No.: US 2022/0108628 A1
(43) Pub. Date: Apr. 7, 2022

(54) Bathroom Hygiene Training System

(71) Applicant: Bradford Santy, East Syracuse, NY (US)

(72) Inventor: Bradford Santy, East Syracuse, NY (US)

(21) Appl. No.: 17/061,658

(22) Filed: Oct. 2, 2020

(51) Int. Cl. G09B 19/00

(52) U.S. Cl. CPC G09B 19/0076; G09B 19/0007

(57) ABSTRACT

A bathroom hygiene training system for training children to put the toilet seat down, flush, and wash their hands includes a trainer apparatus, a seat position apparatus, and a soap dispenser apparatus. The trainer apparatus comprises a trainer housing coupled to a wall of a bathroom. A plurality of task complete sensors coupled to the trainer housing includes a seat down sensor, a flush sensor, and a hands washed sensor. The flush sensor detects when a toilet has been flushed. The seat position apparatus comprises a seat sensor housing to detect when the seat is in an up position or a down position. The soap dispenser apparatus comprises a dispenser body configured to hold and dispense liquid soap. A dispenser sensor detects when the dispenser body has dispensed soap to notify the trainer apparatus the tasks have all been completed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bathroom training devices and more particularly pertains to a new bathroom training device for training children to put the toilet seat down, flush, and wash their hands.

### (2) Description of Related Art Including Information Disclosed Under 37 CFR 1.97 and 1.98

The prior art relates to bathroom training devices. Known toilet training devices are designed to help children pee in the toilet and are largely focused on aim and flushing. These devices do not incorporate a sensor for the seat position and also have no integration with a soap dispenser. Known devices thus do not help train a full bathroom routine of flushing, putting the seat down, and washing hands.

### BRIEF SUMMARY OF THE INVENTION

An embodiment of the disclosure meets the needs presented above by generally comprising a trainer apparatus, a seat position apparatus, and a soap dispenser apparatus. The trainer apparatus comprises a trainer housing having a trainer housing front side, a trainer housing back side, and a trainer housing sidewall. The trainer housing is configured to be coupled to a wall of a bathroom. A trainer CPU is coupled within the trainer housing. A display is coupled to the trainer housing and is in operational communication with the trainer CPU. A trainer battery is coupled to the trainer housing and is in operational communication with the trainer CPU. A plurality of task complete sensors is coupled to the trainer housing. Each task complete sensor is in operational communication with the trainer CPU. The plurality of task complete sensors includes a seat down sensor, a flush sensor, and a hands washed sensor. The flush sensor is configured to detect when a toilet has been flushed. The seat position apparatus comprises a seat sensor housing configured to be coupled to a seat of the toilet. A seat position sensor is coupled within the seat sensor housing and is configured to detect when the seat is in an up position or a down position. A seat position transceiver is coupled within the seat sensor housing. The seat position transceiver is in wireless communication with the seat down sensor of the trainer apparatus. A seat position battery is coupled within the seat sensor housing and is in operational communication with the seat position sensor and the seat position transceiver. The soap dispenser apparatus comprises a dispenser body configured to hold and dispense liquid soap. A dispenser sensor is coupled to the dispenser body. The dispenser sensor detects when the dispenser body has dispensed soap. A dispenser transceiver is coupled within the dispenser body. The dispenser transceiver is in wireless communication with the hands washed sensor. A dispenser battery is coupled within the dispenser body and is in operational communication with the dispenser sensor and the dispenser transceiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a bathroom hygiene training system according to an embodiment of the disclosure.

FIG. 2 is a front elevation view of an embodiment of the disclosure.

FIG. 3 is a bottom plan view of an embodiment of the disclosure.

FIG. 4 is a rear elevation view of an embodiment of the disclosure.

FIG. 5 is an isometric view of an embodiment of the disclosure.

FIG. 6 is an isometric view of an embodiment of the disclosure.

FIG. 7 is a side elevation view of an embodiment of the disclosure.

FIG. 8 is a block diagram view of an embodiment of the disclosure.

### DETAILED DESCRIPTION OF THE INVENTION

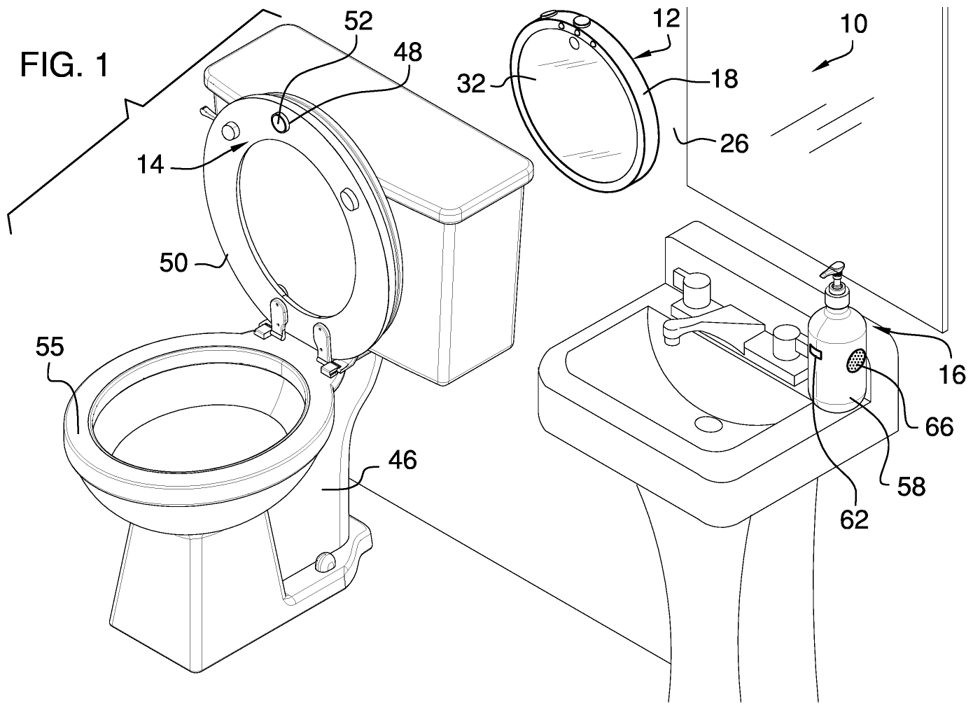

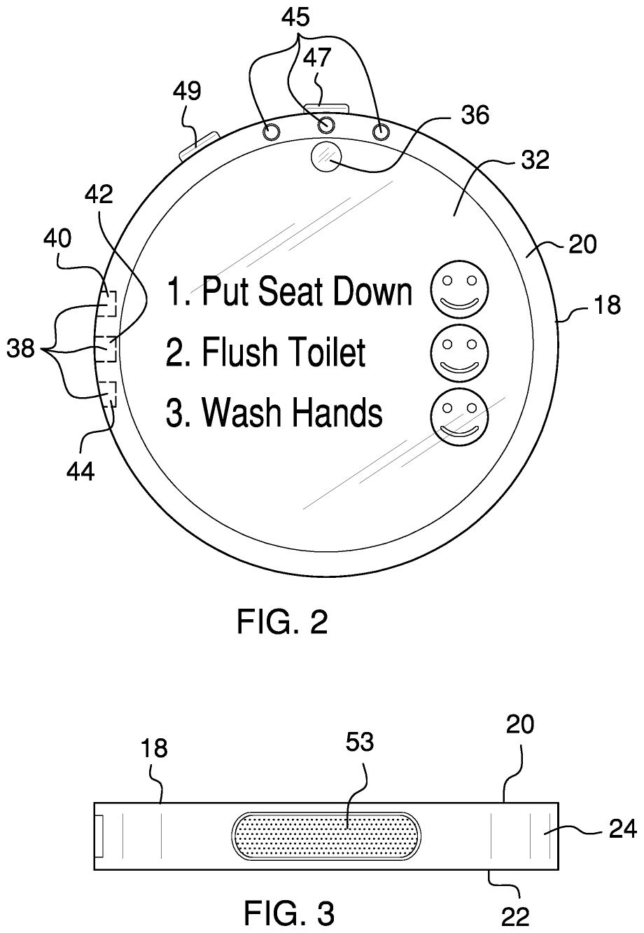

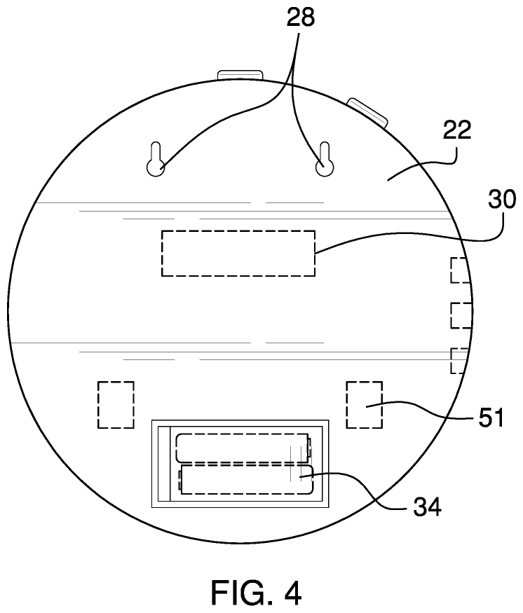

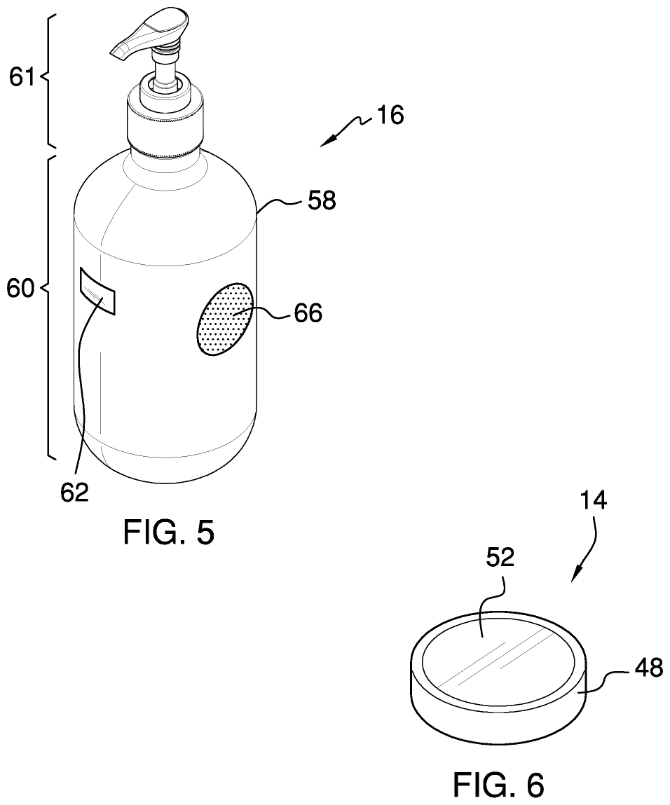

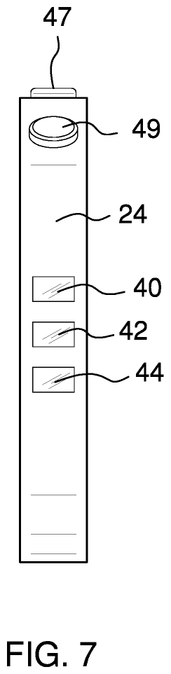

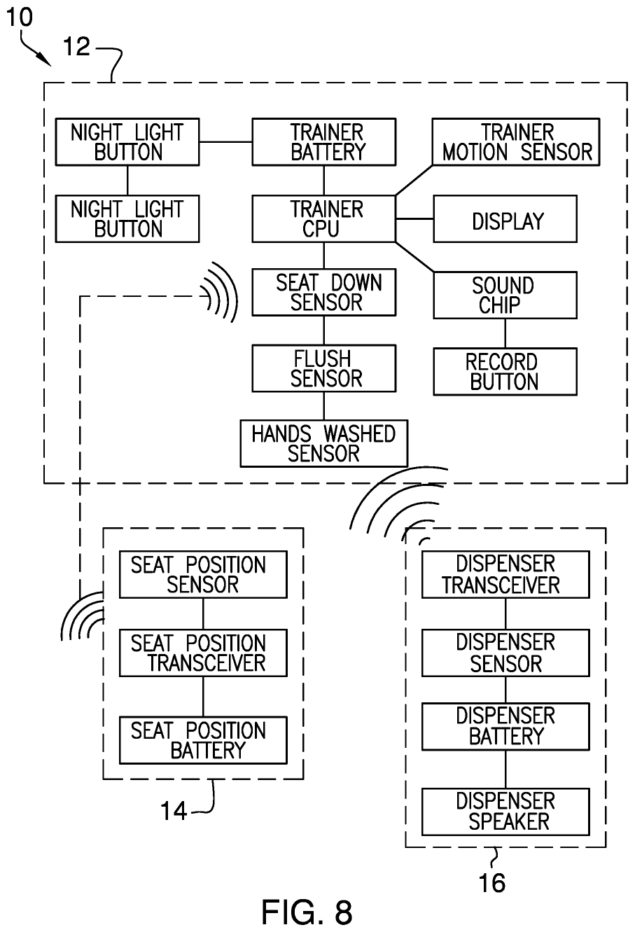

With reference now to the drawings, and in particular to FIGS. 1 through 8 thereof, a new bathroom training device embodying the principles and concepts of an embodiment of the disclosure and generally designated by the reference numeral 10 will be described.

As best illustrated in FIGS. 1 through 8, the bathroom hygiene training system 10 generally comprises a trainer apparatus 12, a seat position apparatus 14, and a soap dispenser apparatus 16. The trainer apparatus 12 comprises a trainer housing 18. The trainer housing 18 may be round and has a trainer housing front side 20, a trainer housing back side 22, and a trainer housing sidewall 24. The trainer housing 18 is configured to be coupled to a wall 26 of a bathroom. The trainer housing back side 22 may have a pair of mounting apertures 28 to receive hardware installed in the wall 26.

A trainer CPU 30 is coupled within the trainer housing 18. A display 32 is coupled to the trainer housing 18. The display 32 may be circular and coupled to the trainer housing front side 20. The display 32 is in operational communication with the trainer CPU 30. A trainer battery 34 is coupled to the trainer housing 18 and is in operational communication with the trainer CPU 30. A trainer motion sensor 36 is coupled to the trainer housing 18 and is in operational communication with the trainer CPU 30 to activate the apparatus 14 when someone walks into the bathroom.

A plurality of task complete sensors 38 is coupled to the trainer housing 12. Each task complete sensor 38 is in operational communication with the trainer CPU 30. The plurality of task complete sensors 38 includes a seat down sensor 40, a flush sensor 42, and a hands washed sensor 44. The flush sensor 42 is configured to detect when a toilet 46 has been flushed. The flush sensor 42 may include an auditory sensor to detect the sound of the toilet 46 flushing.

A plurality of LED lights 45 is coupled to the trainer housing 12 and is in operational communication with the trainer battery 34. A night light button 47 is coupled to the trainer housing 18 and is in operational communication with the plurality of LED lights 45. The plurality of LED lights 45 may include a set of three LED lights 45 coupled to the trainer housing front side 20. A record button 49 may be coupled to the trainer housing 12. A sound chip 51 is coupled within the trainer housing 18. The sound chip 51 is in operational communication with the record button 49 and the trainer CPU 30. A trainer speaker 53 may be coupled to the trainer housing 18 and is in operational communication with the sound chip 51.

The seat position apparatus 14 comprises a seat sensor housing 48 configured to be coupled to a seat 50 of the toilet. The seat sensor housing 48 may have an adhesive layer coupled to the seat 50 and may be circular. A seat position sensor 52 is coupled within the seat sensor housing 48. The seat position sensor 52 is configured to detect when the seat 50 is in an up position or a down position and may have an optical element to detect a rim 55 of the toilet in order to do so. A seat position transceiver 54 is coupled within the seat sensor housing 48 and is in wireless communication with the seat down sensor 40 of the trainer apparatus. A seat position battery 56 is coupled within the seat sensor housing 48 and is in operational communication with the seat position sensor 52 and the seat position transceiver 54.

The soap dispenser apparatus 16 comprises a dispenser body 58 configured to hold and dispense liquid soap by having a reservoir portion 60 and a pump head portion 61. A dispenser sensor 62 is coupled to the dispenser body 58. The dispenser sensor 62 detects when the dispenser body 58 has dispensed soap either by detecting motion or proximity of a user's hand adjacent the soap dispenser apparatus 16 or by detecting movement of the pump head portion 61. A dispenser transceiver 64 is coupled within the dispenser body 58 and is in wireless communication with the hands washed sensor 44. A dispenser speaker 66 may be coupled to the dispenser body 48 and is in operational communication with the dispenser transceiver 64. A dispenser battery 68 is coupled within the dispenser body 48 and is in operational communication with the dispenser sensor 62 and the dispenser transceiver 64.

In use, the trainer apparatus 12 is activated and the display 32 shows the three tasks to be completed. Once each task of the plurality of task complete sensors 38 has been detected as complete the display 32 shows a smiley face 68 adjacent the task. The record button 49 may be used to record instructions or reminders to the sound chip 51 to be played through the trainer speaker 53 and the dispenser speaker 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bathroom hygiene training system comprising:
a trainer apparatus comprising:
a trainer housing, the trainer housing having a trainer housing front side, a trainer housing back side, and a trainer housing sidewall, the trainer housing being configured to be coupled to a wall of a bathroom;
a trainer CPU coupled within the trainer housing;
a display coupled to the trainer housing, the display being in operational communication with the trainer CPU;
a trainer battery coupled to the trainer housing, the trainer battery being in operational communication with the trainer CPU; and
a plurality of task complete sensors coupled to the trainer housing, each task complete sensor being in operational communication with the trainer CPU, the plurality of task complete sensors including a seat down sensor, a flush sensor, and a hands washed sensor, the flush sensor being configured to detect when a toilet has been flushed;
a seat position apparatus comprising:
a seat sensor housing configured to be coupled to a seat of the toilet;
a seat position sensor coupled within the seat sensor housing, the seat position sensor being configured to detect when the seat is in an up position or a down position;
a seat position transceiver coupled within the seat sensor housing, the seat position transceiver being in wireless communication with the seat down sensor of the trainer apparatus; and
a seat position battery coupled within the seat sensor housing, the seat position battery being in operational communication with the seat position sensor and the seat position transceiver; and
a soap dispenser apparatus comprising:
a dispenser body, the dispenser body being configured to hold and dispense liquid soap;
a dispenser sensor coupled to the dispenser body, the dispenser sensor detecting when the dispenser body has dispensed soap;
a dispenser transceiver coupled within the dispenser body, the dispenser transceiver being in wireless communication with the hands washed sensor; and
a dispenser battery coupled within the dispenser body, the dispenser battery being in operational communication with the dispenser sensor and the dispenser transceiver.

2. The bathroom hygiene training system of claim 1 further comprising a trainer motion sensor coupled to the trainer housing, the trainer motion sensor being in operational communication with the trainer CPU.

3. The bathroom hygiene training system of claim 1 further comprising the trainer housing being round and the display being circular and coupled to the trainer housing front side.

4. The bathroom hygiene training system of claim 1 further comprising a plurality of LED lights coupled to the trainer housing, the plurality of LED lights being in operational communication with the trainer battery; a night light button coupled to the trainer housing, the night light button being in operational communication with the plurality of LED lights.

5. The bathroom hygiene training system of claim 4 further comprising the plurality of LED lights including a set of three LED lights coupled to the trainer housing front side.

6. The bathroom hygiene training system of claim 1 further comprising the trainer housing back side having a pair of mounting holes configured to receive wall-mounted hardware.

7. The bathroom hygiene training system of claim 1 further comprising a record button coupled to the trainer housing; a sound chip coupled within the trainer housing, the sound chip being in operational communication with the record button and the trainer CPU; and a trainer speaker coupled to the trainer housing, the trainer speaker being in operational communication with the sound chip.

8. The bathroom hygiene training system of claim 7 further comprising a dispenser speaker coupled to the dispenser body, the dispenser speaker being in operational communication with the dispenser transceiver.

9. A bathroom hygiene training system comprising:
a trainer apparatus comprising:
a trainer housing, the trainer housing being round and having a trainer housing front side, a trainer housing back side, and a trainer housing sidewall, the trainer housing being configured to be coupled to a wall of a bathroom;
a trainer CPU coupled within the trainer housing;
a display coupled to the trainer housing, the display being circular and coupled to the trainer housing front side, the display being in operational communication with the trainer CPU;
a trainer battery coupled to the trainer housing, the trainer battery being in operational communication with the trainer CPU;
a trainer motion sensor coupled to the trainer housing, the trainer motion sensor being in operational communication with the trainer CPU;
a plurality of task complete sensors coupled to the trainer housing, each task complete sensor being in operational communication with the trainer CPU, the plurality of task complete sensors including a seat down sensor, a flush sensor, and a hands washed sensor, the flush sensor being configured to detect when a toilet has been flushed;
a plurality of LED lights coupled to the trainer housing, the plurality of LED lights being in operational communication with the trainer battery; a night light button coupled to the trainer housing, the night light button being in operational communication with the plurality of LED lights, the plurality of LED lights including a set of three LED lights coupled to the trainer housing front side; and
a record button coupled to the trainer housing; a sound chip coupled within the trainer housing, the sound chip being in operational communication with the record button and the trainer CPU; and a trainer speaker coupled to the trainer housing, the trainer speaker being in operational communication with the sound chip;
a seat position apparatus comprising:
a seat sensor housing configured to be coupled to a seat of the toilet;
a seat position sensor coupled within the seat sensor housing, the seat position sensor being configured to detect when the seat is in an up position or a down position;
a seat position transceiver coupled within the seat sensor housing, the seat position transceiver being in wireless communication with the seat down sensor of the trainer apparatus; and
a seat position battery coupled within the seat sensor housing, the seat position battery being in operational communication with the seat position sensor and the seat position transceiver; and
a soap dispenser apparatus comprising:
a dispenser body, the dispenser body being configured to hold and dispense liquid soap;
a dispenser sensor coupled to the dispenser body, the dispenser sensor detecting when the dispenser body has dispensed soap;
a dispenser transceiver coupled within the dispenser body, the dispenser transceiver being in wireless communication with the hands washed sensor;
a dispenser speaker coupled to the dispenser body, the dispenser speaker being in operational communication with the dispenser transceiver; and
a dispenser battery coupled within the dispenser body, the dispenser battery being in operational communication with the dispenser sensor and the dispenser transceiver.
